(19) United States
(12) Patent Application Publication
(10) Pub. No.: US 2005/0168129 A1
(43) Pub. Date: Aug. 4, 2005

(54) Flat panel display device and method of manufacturing the same

(76) Inventor: Eung-Joon Chi, Suwon-si (KR)

Correspondence Address: CHRISTIE, PARKER & HALE, LLP, PO BOX 7068, PASADENA, CA, 91109-7068, US

(21) Appl. No.: 11/046,503

(22) Filed: Jan. 28, 2005

(30) Foreign Application Priority Data
Jan. 30, 2004 (KR) 10-2004-0005969

(51) Int. Cl. H01J 1/05; H01J 1/14; H01J 9/04; H01J 9/12

(52) U.S. Cl. 313/495; 313/311; 445/50; 445/51

(57) ABSTRACT

A flat panel display device includes a first substrate and a second substrate disposed to oppose each other with a predetermined gap therebetween. An electrode made of a transparent conductive oxide film is formed on at least one of the first substrate and the second substrate. A sealing member is disposed between the first substrate and the second substrate and bonds the first substrate and the second substrate to each other. An electrode protecting layer is formed on a portion of the electrode overlapping with the sealing member and between the sealing member and the electrode.

### CROSS REFERENCE TO RELATED APPLICATION

This application claims priority to and the benefit of Korean Patent Application No. 10-2004-0005969 filed on Jan. 30, 2004 in the Korean Intellectual Property Office, the entire content of which is incorporated herein by reference.

### BACKGROUND OF THE INVENTION

1. Field of the Invention

The present invention relates to a flat panel display device and a method of manufacturing the flat panel display device, and more particularly, to a flat panel display device in which an increase in electrode resistance may be prevented by forming an electrode protecting layer on a portion of an electrode passing through a sealing member which also eliminates unnecessary voltage drops and prevents a decrease in brightness and decrease in uniformity of image quality, and a method of manufacturing the flat panel display device.

2. Description of the Related Art

Unlike cathode ray tubes that require a large volume and a high voltage, flat panel display devices have a small thickness and are driven with low voltages. Examples of such flat panel display devices include the field emission display (FED), the vacuum fluorescent display (VFD), the lliquid crystal display (LCD), and the plasma display panel (PDP).

In flat panel display devices, an upper substrate and a lower substrate are disposed with a predetermined gap, and a vacuum vessel is formed by sealing the circumferential edges of the upper substrate and the lower substrate with a sealing member.

The upper substrate or the lower substrate is provided with anode electrodes, grid electrodes, cathode electrodes, gate electrodes, etc. In addition, electrode pads for connecting the electrodes to an external power source are formed on the upper substrate or the lower substrate such that the electrode pads extend from the respective electrodes and are drawn out to the outside of the sealing member.

The anode electrodes and the gate electrodes or the cathode electrodes are made of a transparent indium tin oxide (ITO) thin film, and the electrode pads are also made of a transparent ITO thin film.

In the conventional flat panel display device, the sealing process using frit as the sealing member is performed in a state where the electrodes and the electrode pads are formed on the upper substrate and/or the lower substrate. The processing temperature is kept at 300° C. or higher.

When the substrates are sealed with the frit at a temperature of 300° C. or higher, the portions of the respective ITO thin films contacting the frit are decomposed into their ingredients in the course of baking and curing the frit, thereby causing variation of the initial composition.

Since a part of oxygen required for removing organic matters among the components is supplied from the ITO thin films, the ITO thin films contacting the frit are decomposed into their ingredients.

Since the variation in composition of the ITO thin film increases the inherent resistance thereof and the increase in resistance causes the voltage drop of the corresponding electrode, the abilities of the electrodes are deteriorated.

As a result, the flat panel display device is subjected to deterioration in image quality such as decrease in brightness and decrease in uniformity of brightness due to deterioration in ability of the electrodes, thereby lowering the performance of the display device. There is a need, therefore, for a flat panel display device wherein a decrease in brightness and a decrease in the uniformity of bright due to deterioration of electrodes can be prevented.

### SUMMARY OF THE INVENTION

An exemplary embodiment of the present invention provides a flat panel display device in which increase in electrode resistance may be prevented by forming an electrode protecting layer on a portion of an electrode passing through a sealing member which also eliminates unnecessary voltage drops and prevents a decrease in brightness and decrease in uniformity of image quality.

According to an embodiment of the present invention, a flat panel display device is provided having a first substrate and a second substrate disposed to oppose each other with a predetermined gap therebetween, an electrode made of a transparent conductive oxide film formed on at least one of the first substrate and the second substrate, a sealing member disposed between the first substrate and the second substrate and which bonds the first substrate and the second substrate to each other, and an electrode protecting layer formed on a portion of the electrode overlapping with the sealing member and between the sealing member and the electrode.

The electrode protecting layer may be made of conductive metal. Specifically, the electrode protecting layer may be made of at least one material selected from a group consisting of aluminum, chromium, molybdenum, silver, gold, platinum, palladium, copper, nickel, tungsten, molybdenum/tungsten, molybdenum/manganese, plumbum, and tin.

The electrode protecting layer may be formed using a vacuum deposition method or a screen printing method.

The width of the electrode protecting layer may be greater than that of the electrode.

The width of the electrode protecting layer may be less than or substantially equal to that of the electrode. The electrode protecting layer may be formed in a single layer, or a plurality of the electrode protecting layers may be formed at intervals on the electrode.

The transparent conductive oxide film may be made of indium tin oxide.

According to another embodiment of the present invention, a method of manufacturing a flat panel display device is provided. The method includes the steps of: forming an electrode having an electrode pad on at least one of a first substrate and a second substrate, the electrode being made of a transparent conductive oxide film; forming an electrode protecting layer on the electrode pad, the electrode protecting layer being made of conductive metal; and disposing a sealing member on the electrode protecting layer and on circumferential edges of the first substrate and the second substrate and bonding the first substrate and the second substrate to each other.

### BRIEF DESCRIPTION OF THE DRAWINGS

FIG. 1 is a partial perspective view illustrating a flat panel display device according to an embodiment of the present invention.

FIG. 2 is a partial cross-sectional view illustrating the flat panel display device according to an embodiment of the present invention.

FIG. 3 is a partial vertical cross-sectional view illustrating a state where an electrode protecting layer is formed in the flat panel display device according to an embodiment of the present invention.

FIG. 4 is a partial horizontal cross-sectional view illustrating a state where an electrode protecting layer is formed in the flat panel display device according to an embodiment of the present invention.

FIG. 5 is a partial vertical cross-sectional view illustrating a relation between the electrode protecting layer and an electrode pad in the flat panel display device according to an embodiment of the present invention.

FIG. 6 is a flowchart illustrating steps of manufacturing the flat panel display device according to an embodiment of the present invention.

FIGS. 7 and 8 are partial cross-sectional views illustrating a flat panel display device according to an alternate embodiment of the present invention.

FIG. 9A-9C are partial vertical cross-sectional views illustrating a relation between the electrode protecting layer and the electrode pad in the flat panel display device according to the embodiment of FIGS. 7 and 8.

### DETAILED DESCRIPTION

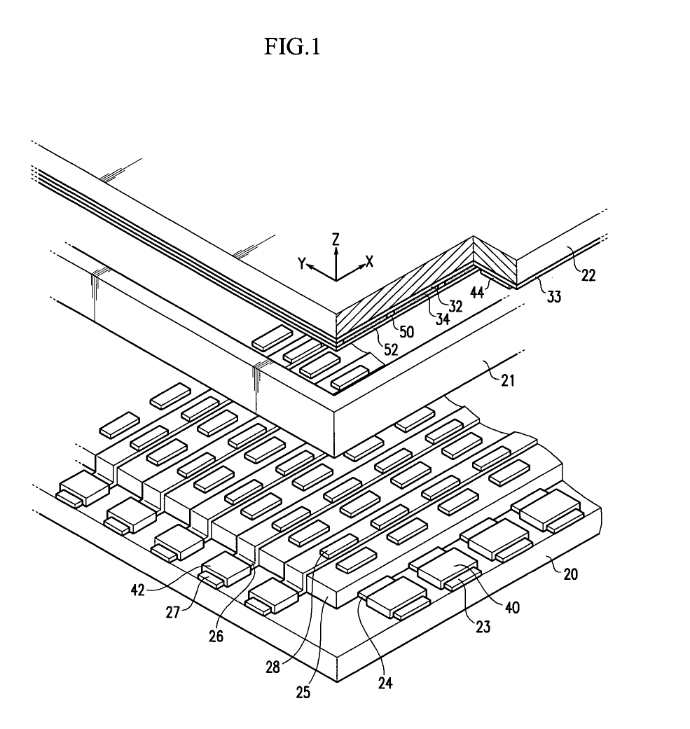

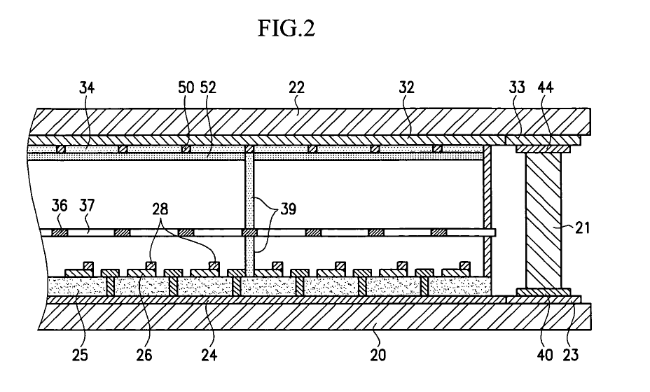

According to one embodiment of the present invention, an FEA type field emission device is shown in FIGS. 1 and 2. The field emission device includes a first substrate 20 and a second substrate 22 disposed to oppose each other with a predetermined gap therebetween. A sealing member 21 is disposed between the circumferential edges of the first substrate 20 and the second substrate 22 which seals the substrates. Gate electrodes 24 and cathode electrodes 26 are formed in a pattern intersecting each other on the first substrate 20 with an insulating layer 25 therebetween. Field emission regions 28 are formed on the portions of the cathode electrodes 26 intersecting the gate electrodes 24.

The field emission device also includes an anode electrode 32 formed on the second substrate 22 and fluorescent film 34 formed in a predetermined pattern on one surface of the anode electrode 32.

In addition, the field emission device may further include black film 50 disposed between the fluorescent film 34 and a metal film 52 formed on the anode electrode 32 to cover the fluorescent film 34 and the black film 50.

In the present embodiment, the anode electrode 32 is made of ITO which forms a transparent conductive film, and the metal film 52 is made of an aluminum (Al) thin film.

The anode electrode is not limited to ITO as described above, but may be made of metal (for example, Al) as needed. In this case, the fluorescent film and the black film are first formed on the second substrate and then the anode electrode made of the metal is formed on the second substrate to cover the fluorescent film and the black film.

The gate electrodes 24, the cathode electrodes 26, and the anode electrodes 32 have pads 23, 27, 33, respectively, formed out of a part of the electrodes for electrical connection to an external driving-voltage applying unit. In the present embodiment, since the electrodes 24, 26, 32 are made of ITO, the pads are also made of ITO.

In a state where the first substrate 20 and the second substrate 22 are sealed with the sealing member 21, the pads 23, 27, 33 are disposed at the inside (inner area of a vacuum vessel formed by the substrates) and the outside (outer area of the vacuum, which is an area on the first substrate or the second substrate) of the sealing member 21 while having areas overlapping with the sealing member.

On the portions of the pads 23, 27, 33 overlapping with the sealing member 21, electrode protecting layers 40, 42, 44 contacting the pads 23, 27, 33, and the sealing member 21 are formed, respectively.

As shown in FIG. 2, between the first substrate 20 and the second substrate 22, a metal mesh-type grid electrode 36 may be further provided in which a plurality of beam-passing holes 37 are arranged in a predetermined pattern. Spacers 39 for keeping constant the gap between the substrates are disposed between both surfaces of the grid electrode 36 and the first and second substrates 20 and 22. For convenience, the grid electrode 36 and the spacers 39 are not shown in FIG. 1.

The gate electrodes 24 and the cathode electrodes 26 may be formed in a stripe pattern and are arranged substantially perpendicular to each other. For example, the gate electrodes 24 are formed in a stripe pattern along the Y axis direction of FIG. 1, and the cathode electrodes 26 are formed in a stripe pattern along the X axis direction of FIG. 1.

Between the gate electrodes 24 and the cathode electrodes 26, the insulating layer 25 is formed over the whole area of the first substrate 20.

At respective areas in which the gate electrodes 24 and the cathode electrodes 26 intersect each other, electron emission regions 28 are formed in the edges of the cathode electrodes 26.

The electron emission regions 28 serve as surface electron sources formed with a uniform thickness, and may be made of a carbon material that emits electrons well under a low-voltage driving condition of about 10 to 100V.

As the carbon material forming the electron emission regions 28, one material selected from graphite, diamond, diamond like carbon (DLC), carbon nano-tube (CNT), C60 (fullerene), etc. or a combination of two or more materials selected therefrom, may be used. Specifically, since the radius of curvature of an end of the carbon nano-tube may be as small as only a few nanometers and the carbon nano-tube emits electrons well in a low electric field of about 1 to 10 V/μm, the carbon nano-tube is an ideal electron-emission material.

On the other hand, the electron emission regions 28 made be made of a nanometer sized material such as nano-tube, nano-fiber, nano-wire, etc.

The electron emission regions 28 are not limited to the above-mentioned examples, but may be formed in various shapes such as a cone shape, a wedge shape, a thin film edge shape, etc.

In the present embodiment as described above, the gate electrodes 24 are formed on the first substrate 20 and the cathode electrodes 26 are formed on the gate electrodes 24 with the insulating layer 25 therebetween. However, the cathode electrodes may be first formed on the first substrate and then the gate electrodes may be formed on the cathode electrodes with the insulating layer therebetween. In this case, holes penetrating the gate electrodes and the insulating layer are formed at the intersections between the cathode electrodes and the gate electrodes, and the electron emission regions are formed on the surface of the cathode electrodes exposed through the holes.

The first substrate 20 and the second substrate 22 having the above-mentioned construction are sealed with a predetermined gap by the sealing member 21 in a state where the cathode electrodes 26 and the fluorescent film 34 are perpendicularly opposed to each other, and the inner space therebetween is exhausted, thereby maintaining a vacuum.

In order to keep constant the gap between the first substrate 20 and the second substrate 22, the spacers 39 are arranged at predetermined intervals between the first substrate 20 and the second substrate 22. In one exemplary embodiment, the spacers 39 are provided to avoid positions of pixels and paths of electron beams.

The electrode pads 23, 27 for applying voltages to the gate electrodes 24 and the cathode electrodes 26 formed on the first substrate 20 and the electrode pads 33 for applying a voltage to the anode electrode 32 formed on the second substrate 22 may be made of ITO.

The electrode protecting layers 40, 42, 44 formed on the electrode pads 23, 27, 33 may be made of conductive metal.

As the conductive metal forming the electrode protecting layers 40, 42, 44, one material selected from a group consisting of aluminum (Al), chromium (Cr), molybdenum (Mo), silver (Ag), gold (Au), platinum (Pt), palladium (Pd), copper (Cu), nickel (Ni), tungsten (W), molybdenum/tungsten (Mo/W), molybdenum/manganese (Mo/Mn), lead (Pb), and tin (Sn) or a combination of two or more materials selected therefrom may be used.

The electrode protecting layers 40, 42, 44 may be formed using a vacuum deposition method or a screen printing method.

When the electrode protecting layers 40, 42, 44 are formed using the screen printing method, a paste of conductive metal may be used.

In one exemplary embodiment, fine particles having a diameter of several microns (μm) or less are used as the conductive metal made into paste to form the electrode protecting layers 40, 42, 44 using the screen printing method.

As shown in FIG. 4, in the present embodiment, the electrode protecting layers 40, 42, 44 may be formed width a width D which is sufficiently greater than the width C of the sealing member 21 so as to completely prevent contact of the electrode pads 23, 27, 33 with the sealing member 21. Here, the width C and the width D are measured in the Y axis direction of FIG. 1.

As further shown in FIG. 4, the electrode protecting layers 40, 42, 44 may be formed with a width B which is sufficiently greater than the width A of the electrode pads 23, 27, 33 so as to completely prevent contact of the electrode pads 23, 27, 33 with the sealing member 21. The electrode protecting layers 40, 42, 44 may be formed to cover the top surfaces and both side surfaces of the electrode pads 23, 27, 33. Here, the width A and the width B are measured in the X axis direction of FIG. 1.

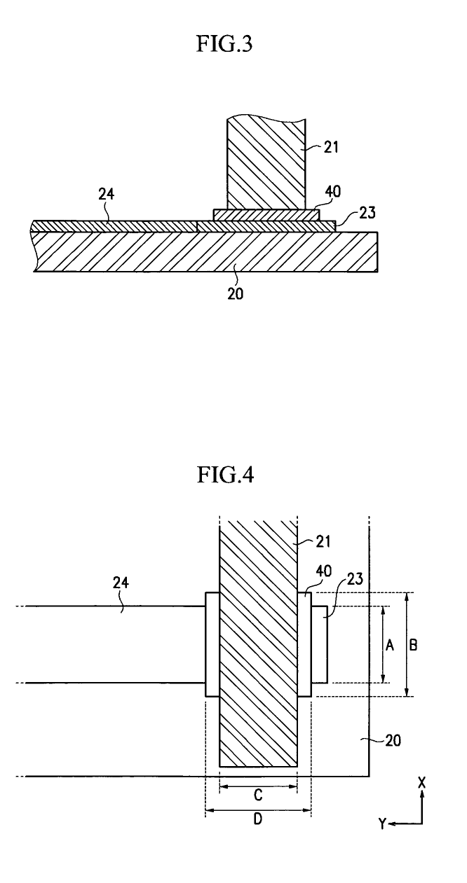

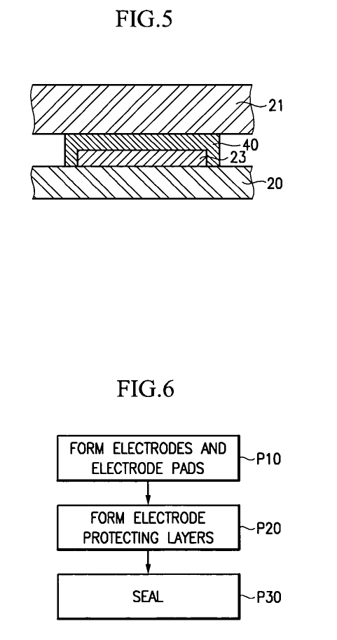

The gate electrodes 24, the electrode pads 23, and the electrode protecting layers 40 are shown in FIGS. 3, 4, and 5.

In an embodiment of a method of manufacturing a flat panel display device, as shown in FIGS. 1, 2, and 6, the electrodes 24, 26, 32 and the electrode pads 23, 27, 33 are first formed on the inner surfaces of the first substrate 20 and the second substrate 22 by using ITO (P10 in FIG. 6). Then, conductive metal is deposited or printed on the electrode pads 23, 27, 33, in areas greater than the portions contacting the sealing member 21, thereby forming the electrode protecting layers 40, 42, 44 (P20 in FIG. 6). Thereafter, the circumferential portions of the first substrate 20 and the second substrate 22 are sealed with the sealing member 21 (P30 in FIG. 6).

In the step P20 of forming the electrode protecting layers 40, 42, 44, conductive metals such as aluminum (Al), chromium (Cr), molybdenum (Mo), silver (Ag), gold (Au), platinum (Pt), palladium (Pd), copper (Cu), nickel (Ni), tungsten (W), molybdenum/tungsten (Mo/W), molybdenum/manganese (Mo/Mn), lead (Pb), and tin (Sn) or a combination of two or more materials selected therefrom may be used.

The electrode protecting layers 40, 42, 44 are formed from one of the conductive metal materials or a mixture of two or more of the conductive metal materials by using a vacuum deposition method or a screen printing method. When the electrode protecting layers 40, 42, 44 are formed using the screen printing method, a paste of the conductive metal is used.

The sealing step P30 is performed at a temperature of about 300° C. or higher using frit.

In the sealing step P30, high-temperature heat of about 300° C. or higher is applied. However, since the electrode protecting layers 40, 42, 44 come in direct contact with the frit serving as the sealing member 21, but the electrode pads 23, 27, 33 made of ITO do not come in direct contact with the frit serving as the sealing member 21, thermal decomposition is slight and there is little to no increase in resistance.

According to an embodiment of the flat panel display device of the present invention and the method of manufacturing the flat panel display device, even when the sealing step using the sealing member and the exhausting step are performed at a temperature of 300° C. or higher, the electrode pads made of an ITO thin film are protected by the electrode protecting layers. Therefore, the resistances of the electrode pads and the electrodes having the electrode pads are not increased, thus preventing unnecessary voltage drop from occurring.

As a result, since the flat panel display device does not undergo a decrease in brightness and a decrease in driving voltage, it is possible to enhance the uniformity of image quality.

Although the FEA type field emission device has been used as an example, embodiments of the present invention are not limited to this type of is device. Rather, embodiments of the present invention may be applied to different kinds of flat panel display devices such as a PDP, an organic electroluminescence device (OLED), an LCD, etc.

Although it has been described in the above-mentioned embodiments that all the electrodes formed on the first substrate and the second substrate and the electrode pads of the electrodes are made of ITO and the electrode protecting layers are formed on the electrode pads, the present invention is not limited to the embodiments, but may be applied to a case where at least one electrode to be formed on the first substrate or the second substrate and an electrode pad of the at least one electrode are made of ITO and an electrode protecting layer is formed on the electrode pad.

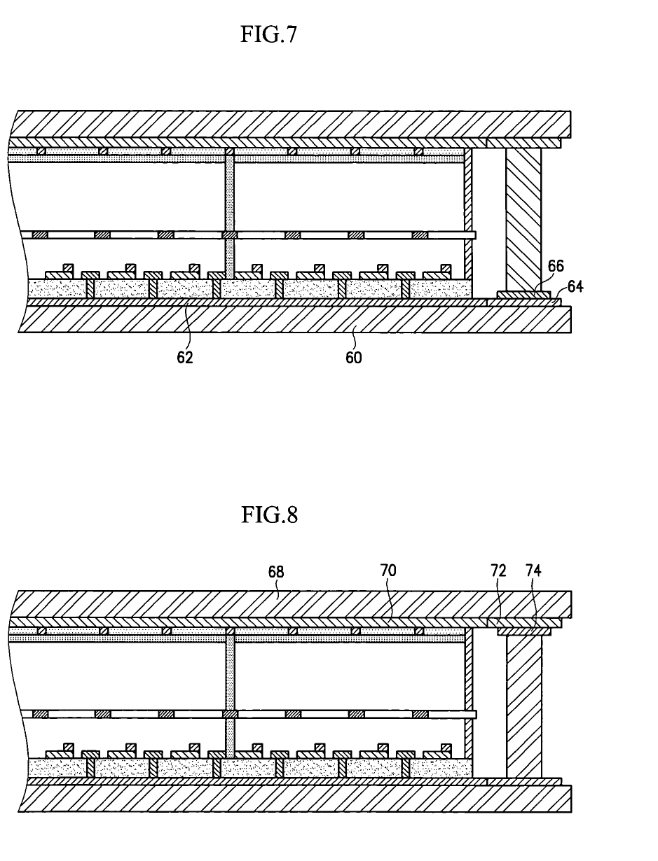

For example, FIG. 7 shows a case where only gate electrodes 62 formed on a first substrate 60 and electrode pads 64 of the gate electrodes 62 are made of ITO and electrode protective layers 66 are formed on the electrode pads 64.

In another example, FIG. 8 shows a case where only an anode electrode 70 formed on a second substrate 68 and an electrode pad 72 of the anode electrode 70 are made of ITO and an electrode protecting layer 74 is formed on the electrode pad 72.

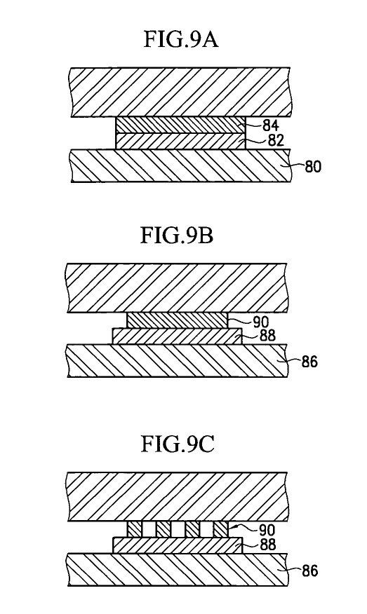

Additionally, FIGS. 9A to 9C are cross-sectional views illustrating various patterns of an electrode protecting layer according to the present invention, which are viewed from the Y axis direction of FIG. 1. In the figures, an electrode pad of a gate electrode formed on a first substrate and an electrode protecting layer formed on the electrode pad are exemplified.

FIG. 9A shows a case where the width of the electrode pad 82 of the gate electrode formed on the first substrate 80 is substantially equal to the width of the electrode protecting layer 84 formed on the electrode pad 82.

FIGS. 9B and 9C show a case where the width of the electrode protecting layer 90 is less than the width of the electrode pad 88 in a state that the electrode pad 88 and the electrode protecting layer 90 of the gate electrode are sequentially formed on the first substrate 86.

In this case, the electrode protecting layer 90 may be formed in a single body (see FIG. 9B), or may be formed in plural portions with intervals (see FIG. 9C).

Although exemplary embodiments of the present invention have been described, the present invention is not limited to the exemplary embodiments, but rather may be modified in various forms without departing from the scope of the appended claims, the detailed description, and the accompanying drawings of the present invention. Therefore, it will be understood by those skilled in the art that such modifications belong to the scope of the present invention.

1. A flat panel display device comprising:
a first substrate and a second substrate disposed opposite to each other with a predetermined gap therebetween;
an electrode made of a transparent conductive oxide film formed on at least one of the first substrate and the second substrate;
a sealing member disposed between the first substrate and the second substrate which bonds the first substrate and the second substrate to each other; and
an electrode protecting layer formed on a portion of the electrode overlapping with the sealing member and between the sealing member and the electrode.

2. The flat panel display device of claim 1, wherein the electrode protecting layer is made of conductive metal.

3. The flat panel display device of claim 2, wherein the electrode protecting layer is made of at least one material selected from a group consisting of aluminum, chromium, molybdenum, silver, gold, platinum, palladium, copper, nickel, tungsten, molybdenum/tungsten, molybdenum/manganese, plumbum, and tin.

4. The flat panel display device of claim 1, wherein the electrode protecting layer is formed using a vacuum deposition method or a screen printing method.

5. The flat panel display device of claim 1, wherein the width of the electrode protecting layer is greater than that of the electrode.

6. The flat panel display device of claim 1, wherein the width of the electrode protecting layer is substantially equal to that of the electrode.

7. The flat panel display device of claim 1, wherein the width of the electrode protecting layer is less than that of the electrode.

8. The flat panel display device of claim 7, wherein the electrode protecting layer is formed in a single layer.

9. The flat panel display device of claim 7, wherein a plurality of the electrode protecting layers are formed at intervals on the electrode.

10. The flat panel display device of claim 1, wherein the transparent conductive oxide film is made of indium tin oxide.

11. A method of manufacturing a flat panel display device, the method comprising:
forming an electrode having an electrode pad on at least one of a first substrate and a second substrate, the electrode being made of a transparent conductive oxide film;
forming an electrode protecting layer on the electrode pad, the electrode protecting layer being made of conductive metal; and
disposing a sealing member on the electrode protecting layer and on the circumferential edges of the first substrate and the second substrate and then bonding the first substrate and the second substrate to each other.

12. The method of claim 11, wherein the electrode protecting layer is formed using a vacuum deposition method or a screen printing method.

13. The method of claim 11, wherein the electrode protecting layer is made of at least one material selected from a group consisting of aluminum, chromium, molybdenum, silver, gold, platinum, palladium, copper, nickel, tungsten, molybdenum/tungsten, molybdenum/manganese, plumbum, and tin.

14. The method of claim 11, wherein the electrode is made of indium tin oxide.
